(19) United States
(12) Patent Application Publication
(10) Pub. No.: US 2004/0123233 A1
(43) Pub. Date: Jun. 24, 2004

(54) System and method for automatic tagging of ducuments

(76) Inventors: Daniel Joseph Cleary, Schenectady, NY (US); Jeremiah Francis Donoghue, Ballston Lake, NY (US); Steven Hector Azzaro, Schenectady, NY (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/325,966

(22) Filed: Dec. 23, 2002

(51) Int. Cl. G06F 9/44

(52) U.S. Cl. 715/513; 715/530; 717/114

(57) ABSTRACT

The present invention provides a system and method for automatically tagging documents with a given set of user-defined tags. The present invention takes as input the document to be tagged, and also a list of tags along with keywords belonging to these tags. The present invention then selects a tag, and scans the document for sentences that have keywords corresponding to the selected tag. Sentences that match the keywords are tagged with the selected tag. Once the whole document has been scanned, the present invention selects the next tag and repeats the whole process. This process is repeated until all tags have been seen.

### BACKGROUND OF THE INVENTION

The present invention relates to the field of document tagging. More specifically, the present invention is a system and method for automatically tagging documents with extended Markup Language (XML) tags.

Most business organizations create knowledge as part of their day-today activities and various projects. To ensure that this knowledge is not lost and can be reused later, proper management of the knowledge is necessary. To this end, business organizations typically store their knowledge in documents, and manage the knowledge using knowledge management tools and applications.

A typical example of a business organization that creates knowledge is a call center. Call centers have customers, technicians, and others calling in with problems, to which solutions are provided by the call center professionals. This process produces knowledge, in the form of problems and solutions associated with them. To efficiently reuse this created knowledge, the problems and their associated solutions are stored in documents known as “case notes”, which are used by other call center operators to lookup and suggest solutions to problems that have already been solved.

A key issue in using case notes is the process of extracting knowledge from it. A lot of times, case notes are stored in an unstructured textual format, and thus do not lend themselves well towards searching and extracting. The only methods of extracting knowledge from these unstructured notes is to search through the document in a linear manner, or to use tools like search engines. These methods perform their search by matching text in a user query with text in the case note. That is to say, a user query like “find all cases where the solution was to replace the regulator” will fetch all cases that have the words “replace” and “regulator”, irrespective of whether the act of replacing the regulator was part of the solution or not. These methods are thus unable to do a fine-grained search of case notes, and hence not very useful.

To improve the knowledge extraction process, documents such as case notes are typically tagged with markup tags. Tagging a document classifies the contents of the document, and makes searching the document easier. A markup language that is commonly used to tag documents is the extended Markup Language (XML).

Tagging can be done in various ways. One of these is to manually tag the document. While tagging a document manually, a person goes through the whole document and types the tag for each element. Manual tagging, however, is quite cumbersome and has many disadvantages. Firstly, while manual tagging is possible for small documents, it becomes cumbersome for huge documents such as case notes, which contain a large number of case histories. Secondly, manual tagging requires that the person carrying out the tagging process should have knowledge of XML. And thirdly, manual tagging requires that the person carrying out the tagging process should know the context of the document, and therefore such a person should have expertise in the domain or context to which the document belongs.

Another way to tag a document is to use an XML editor. XML editors allow users to tag elements in a document by selecting a word or collection of words in the document, and then assigning a tag by selecting an appropriate tag from a list of tags. This tagging is done through a Graphical User Interface (GUI), using a mouse or any other associated device, and is thus very intuitive and user-friendly. XML editors too, however, have disadvantages. For one, XML editors also require that the person carrying out the tagging process should know the context of each element in the document, and therefore have expertise in the domain or context to which the document belongs. And for another, XML editors require that the person tagging the document go through the entire document and then tag the appropriate elements, hence making it a cumbersome process.

Disadvantages such as the above make manual tagging and XML editors an undesired way of tagging documents. Instead, what is desired is a method that automatically tags a document with a given set of user-defined tags.

Therefore, there exists a need for a solution that automatically tags documents with a given set of user-defined tags. The solution should also be cost-effective and should not require users to have knowledge of the markup language.

Accordingly, the present invention addresses these problems and others.

### BRIEF SUMMARY OF THE INVENTION

The present invention provides a system and method for automatically tagging documents with a given set of user-defined tags.

In accordance with one aspect, the present invention provides a method for automatically tagging text in an input text document, such that the method also takes as input a list of user-defined tags and a list of keywords corresponding to these tags, and the method tags the input text document by repeatedly selecting a tag from the list of user-defined tags and tagging text in the document that has keywords corresponding to this tag.

In accordance with one aspect, the present invention provides a system for automatically tagging text in an input text document, such that the system has a modifier portion and a tagger portion, and the system also takes as input a list of user-defined tags and a list of keywords corresponding to these tags, and the tagger portion tags the input text document by repeatedly selecting a tag from the list of user-defined tags and tagging text in the document that has keywords corresponding to this tag.

In accordance with one aspect, the present invention provides a computer program product for automatically tagging text in an input text document, such that the computer program product also takes as input a list of user-defined tags and a list of keywords corresponding to these tags, and the computer program product tags the input text document by repeatedly selecting a tag from the list of user-defined tags and tagging text in the document that has keywords corresponding to this tag.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram showing the general environment in which the present invention works, in accordance with one embodiment of the present invention;

FIG. 2 is a flow chart showing the working of the present invention, in accordance with one embodiment of the present invention;

FIG. 3 is screenshot showing an exemplary process of inputting a document to be tagged to the present invention, in accordance with one embodiment of the present invention;

FIG. 4 is a screenshot showing an exemplary tagged document produced by the present invention, in accordance with one embodiment of the present invention;

FIG. 5 is a screenshot showing an exemplary tagged document as displayed by the present invention, in accordance with one embodiment of the present invention.

FIG. 6 shows a block diagram the system of the present invention, in accordance with one embodiment of the present invention.

### DETAILED DESCRIPTION OF THE INVENTION

Hereinafter, aspects in accordance with various embodiments of the present invention will be described. As used herein, any term in the singular may be interpreted to be in the plural, and alternatively, any term in the plural may be interpreted to be in the singular.

The foregoing description of various products, methods, or apparatus and their attendant disadvantages described in the “Background” is in no way intended to limit the scope of the present invention, or to imply that the present invention does not include some or all of the elements of known products, methods, and/or apparatus in one form or another. Indeed, various embodiments of the present invention may be capable of overcoming some of the disadvantages noted in the “Background”, while still retaining some or all of the various elements of known products, methods, and apparatus in one form or another.

The method and system of the present invention are directed to the above stated problems, as well as other problems, that are present in conventional techniques. In particular, the present invention is a system and method for automatic tagging of documents.

In one embodiment, the present invention is envisioned to be operating in conjunction with a case management tool. Case management tools are software tools used at call centers, and are used to manage case notes. Although the case management tool may be variously provided, an example of such a tool is “Clarify”. It may be noted, though, that the present invention may be adapted to operate independent of a case management tool by one skilled in the art.

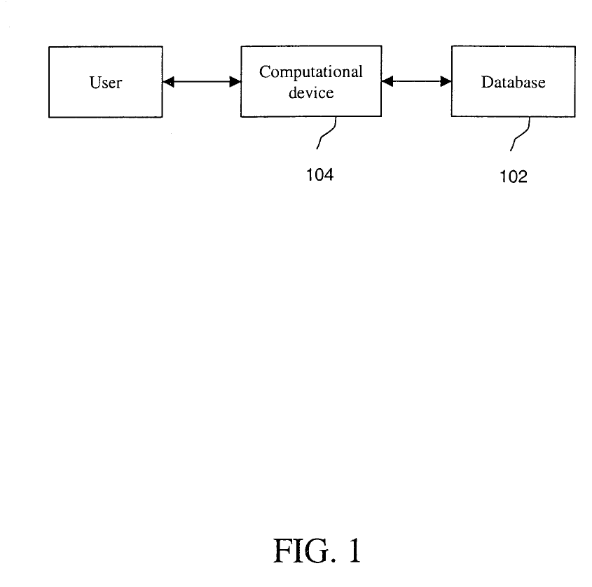

FIG. 1 is a block diagram showing the general environment in which the present invention works, in accordance with one embodiment of the present invention. The system and method of the present invention resides on a computational device 104, and accesses a database 102. Typical examples of computing device 104 include a general-purpose computer, a programmed microprocessor, a micro-controller, a peripheral integrated circuit element, a server and other devices or arrangements of devices. Database 102 contains documents such as case notes. Typical examples of database 102 include Oracle InterMedia and Microsoft SQLServer. A user inputs tags and keywords, and the present invention automatically tags the documents.

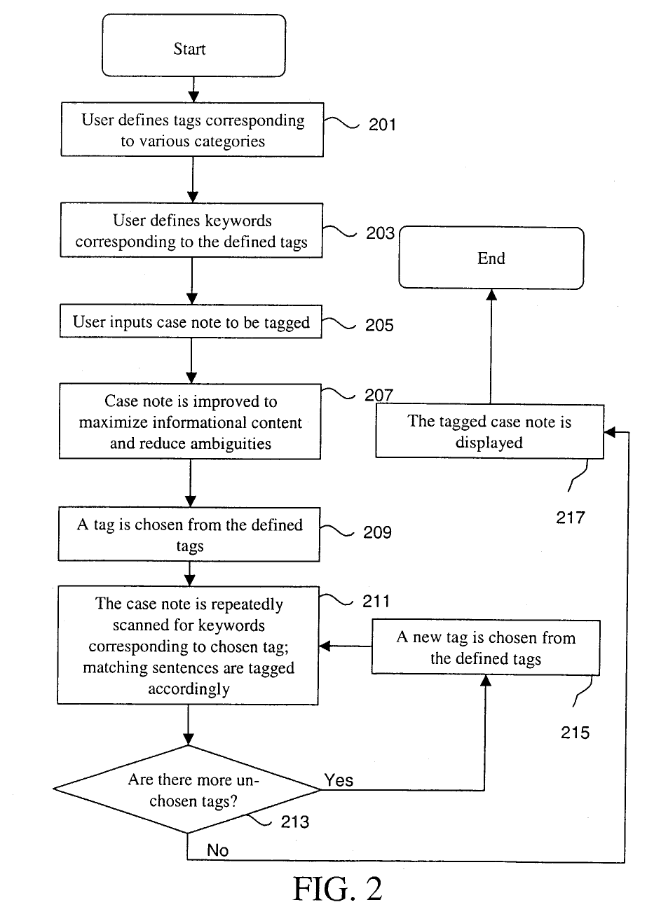

FIG. 2 is a flow chart showing the working of the present invention in accordance with one embodiment of the present invention.

At step 201, a user defines various tags. These tags correspond to various categories according to which the text is to be tagged, and include, for example, <PROBLEM> for “problems”, <SOLUTION> for “solutions” and <PRODUCT> for “products”. These user-defined tags are stored in a list. In one aspect of the present invention, the tags are typed into a Graphical User Interface (GUI) text window.

At step 203, the user defines various keywords. These keywords correspond to the defined tags, and include, for example, words like “DC2000”, “DC5000”, “regulator” and “not working”. Further, while defining these keywords, the user classifies them according to the tag to which they belong. For example, “DC2000” could be classified under tag <PRODUCT>, while “DC5000” could be classified under a tag <PROBLEM>. In one aspect of the present invention, the keywords are typed into a GUI window.

At step 205, the user inputs the document to be tagged. In one aspect of the present invention, the document may be typed into a GUI text window. In another aspect of the present invention, the name of a file containing the document may be typed in a GUI text box. This step is further illustrated by an exemplary screenshot in FIG. 2.

At step 207, the input document is modified to maximize informational content and remove ambiguities. This is in the form of checking spelling, removing stop words, replacing synonyms, and decomposing sentences and parts of speech. This step is used to improve the efficiency of the present invention, by ensuring that no misspelled words or repetition of words occur.

At step 209, a tag is chosen from the list of defined tags. In one aspect of the present invention, the tag chosen is the first in the list.

At step 211, the document is repeatedly scanned for keywords associated with the chosen tag. When a sentence is found containing a keyword, it is tagged as belonging to the category corresponding to that keyword. For example, if a keyword “DC2000” is associated with a tag <PRODUCT>, then a sentence containing the word “DC2000” is tagged as<PRODUCT>. This is done by enclosing the sentence with the tags <PRODUCT> and </PRODUCT>.

To search for keywords in the document, various natural language techniques are used. These include techniques such as keyword and key phrase identification within an identified sentence, but are not limited to these techniques.

Some sentences may contain keywords associated with more than one tag. In such situations, overlapping tags are allowed to coexist. It may be noted that step 207 significantly aids in reducing the number of overlapping tags in a given input document, by removing similar words and spell checking.

At step 213, it is checked if there are more tags in the list of defined tags that have not be chosen so far. If there are more tags, step 215 is executed else step 217 is executed.

At step 215, a new tag is chosen. In one aspect of the present invention, the chosen tag is the next in numerical order in the list of tags. Step 211 is now executed again.

At 217, the tagged document is displayed. This completes the working of the present invention.

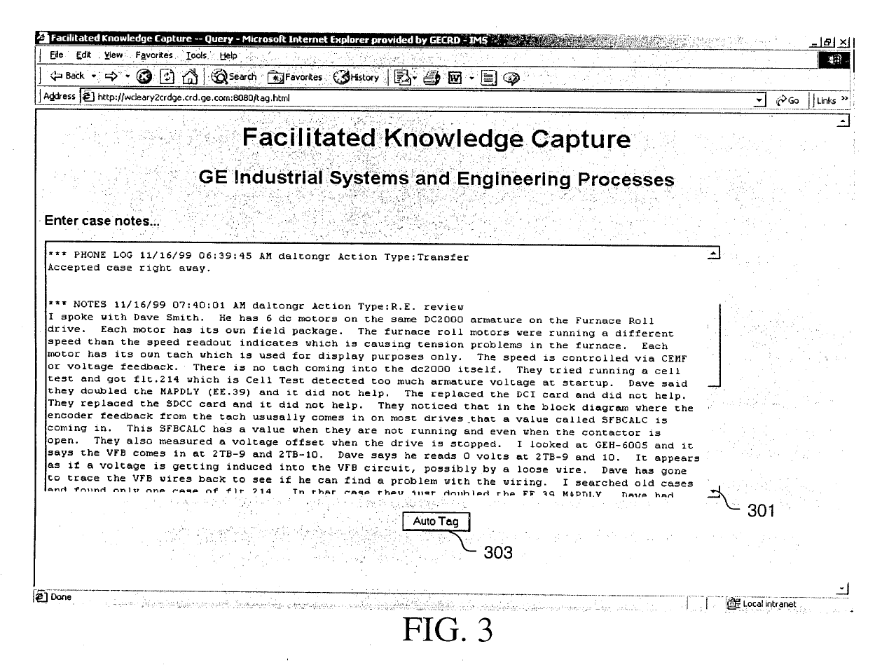

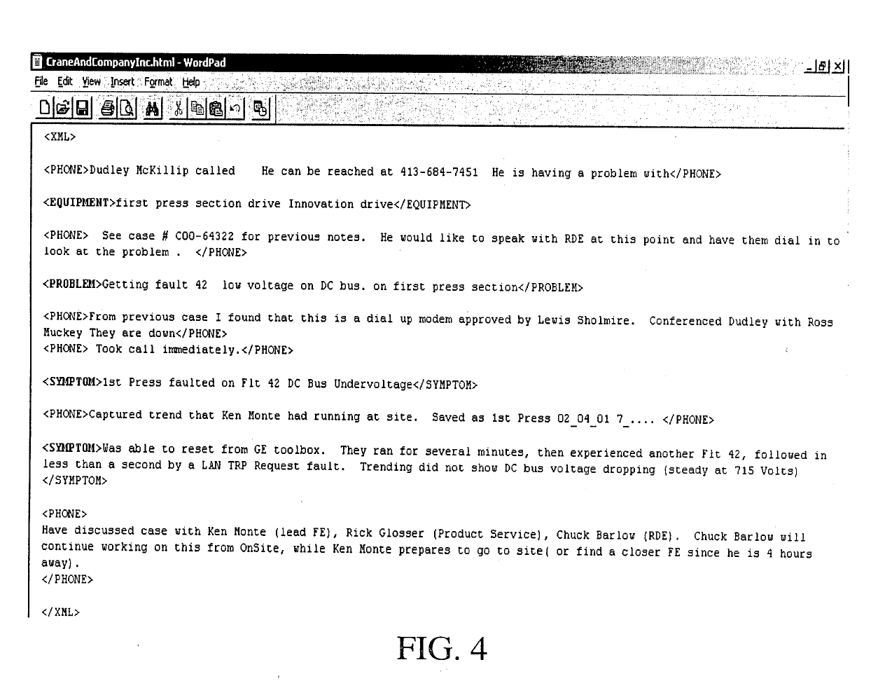

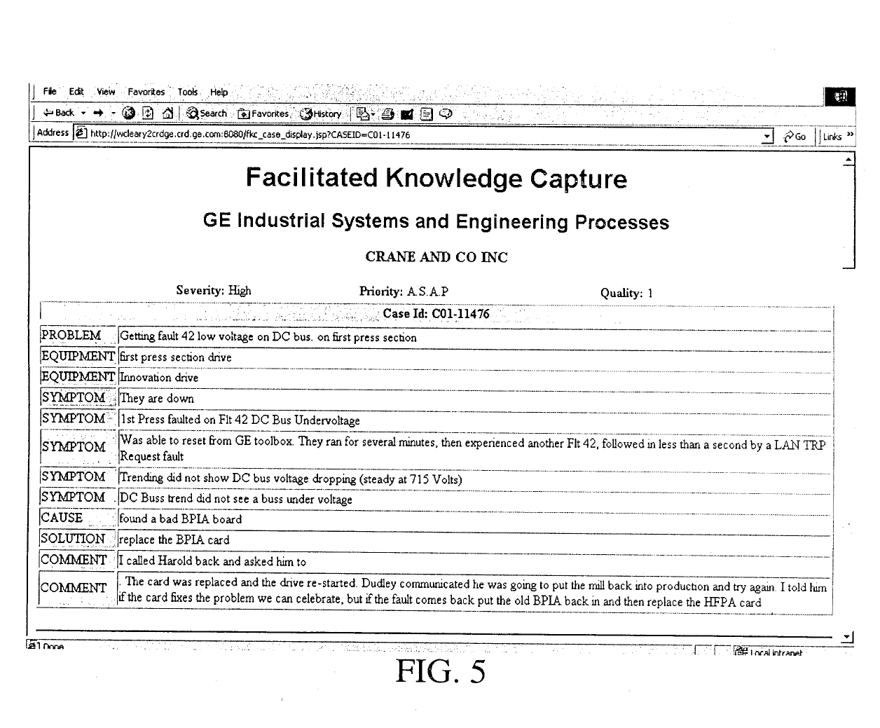

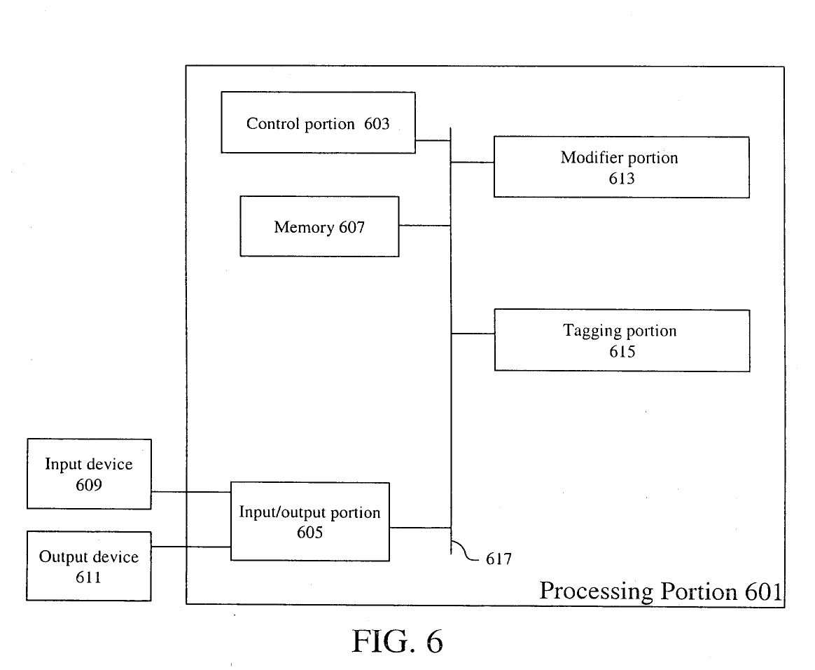

The flowchart of FIG. 2 may be performed by different operating systems in accordance with various embodiments of the present invention. Screenshots of one such illustrative operating system are shown in FIG. 3, FIG. 4 and FIG. 5. Further, one such illustrative operating system is described in FIG. 6.

FIG. 3 is screenshot showing an exemplary process of inputting a document to be tagged to the present invention, in accordance with one embodiment of the present invention. The screenshot shows a text input area 301, wherein the user enters the document to be tagged. After entering the document, the user has to press “Auto Tag” 303 button.

FIG. 4 is a screenshot showing an exemplary tagged document produced by the present invention, in accordance with one embodiment of the present invention. The screenshot shows the same document that was entered in FIG. 3, but with tags like <PHONE>, <EQUIPMENT>, <SYMPTOM> and the like.

FIG. 5 is a screenshot showing an exemplary tagged document as displayed by the present invention, in accordance with one embodiment of the present invention. The screenshot shows the same document that was entered in FIG. 3, but in an easy to read manner.

While displaying a tagged case note, the present invention also displays a quality measure of the document. This is a number between zero and one, and is a measure of relevance of the content in the document.

Although the quality computing heuristic may be variously provided, it may be noted that the present invention may be adapted to operate with various heuristics by one skilled in the art.

Thus, in addition to automatically tagging a document with user-defined tags, the present invention also assigns a measure of quality to each case while displaying them.

In further explanation of the present invention, FIG. 6 shows a block diagram of the system of the present invention, in accordance with one embodiment of the present invention.

FIG. 6 shows a processing portion 601 of the system. Processing portion 601 includes various components, namely a control portion 603, an input/output portion 605 and a memory 607. Control portion 603 controls overall operations of processing portion 601, such as coordinating the operation of the various components. Input/output portion 605 inputs and outputs a variety of data in conjunction with input device 609 and output device 611, respectively. For example, input device 609 might be a scanning device, a keyboard, a mouse or a device to provide connection to the Internet. Output device 611 might be simply a monitor or a database.

Processing portion 601 further includes a modifier portion 613 and a tagging portion 615. Modifier portion 613 is responsible for modifying the input text at step 207, to improve its informational content and remove overlapping tags, while tagger portion 616 is responsible for performing tagging the document at steps 209 to 215, as described in FIG. 2.

The various components of the processing portion 601 are connected using a suitable interface 617, such as a bus.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the present invention.

The system, as described in the present invention or any of its components may be embodied in the form of a processing machine. Typical examples of a processing machine include a general-purpose computer, a programmed microprocessor, a micro-controller, a peripheral integrated circuit element, and other devices or arrangements of devices, which are capable of implementing the steps that constitute the method of the present invention.

The processing machine executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the processing machine to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that it is not necessary that the various processing machines and/or storage elements be physically located in the same geographical location. The processing machines and/or storage elements may be located in geographically distinct locations and connected to each other to enable communication. Various communication technologies may be used to enable communication between the processing machines and/or storage elements. Such technologies include connection of the processing machines and/or storage elements, in the form of a network. The network can be an intranet, an extranet, the Internet or any client server models that enable communication. Such communication technologies may use various protocols such as TCP/IP, UDP, ATM or OSI.

In the system and method of the present invention, a variety of “user interfaces” may be utilized to allow a user to interface with the processing machine or machines that are used to implement the present invention. The user interface is used by the processing machine to interact with a user in order to convey or receive information. The user interface could be any hardware, software, or a combination of hardware and software used by the processing machine that allows a user to interact with the processing machine. The user interface may be in the form of a dialogue screen and may include various associated devices to enable communication between a user and a processing machine. It is contemplated that the user interface might interact with another processing machine rather than a human user. Further, it is also contemplated that the user interface may interact partially with other processing machines, while also interacting partially with the human user.

While the various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

What is claimed is:

1. A method for automatically tagging text in an input text document, the method taking as input a list of user-defined tags and a list of keywords corresponding to the tags, the method comprising the steps of:
a. modifying the input text document; and
b. tagging the input text document by repeatedly selecting a tag from the list of user-defined tags, and tagging text in the input text document that has keywords corresponding to this selected tag.

2. The method as recited in claim 1, wherein the modifying step comprises the steps of:
a. checking spelling of words in the input text document;
b. removing stop words from the input text document;
c. replacing synonyms of words in the input text document; and
d. decomposing sentences and parts of speech in the input text document.

3. The method as recited in claim 1, wherein the tagging step comprises the steps of:
a. selecting a tag from the list of user-defined tags;
b. searching the input text document for text containing keywords corresponding to the selected tag;
c. tagging text in the input text document with tags, if the text has keywords corresponding to the selected tag;
d. iteratively repeating steps a and b until all tags in the list of user-defined tags have been selected; and
e. displaying the tagged input text document.

4. The method as recited in claim 3, wherein the tagging step comprises enclosing the text with XML tags.

5. A system for automatically tagging text in an input text document, the system taking as input a list of user-defined tags and a list of keywords corresponding to the tags, the system comprising:
a. a modifier portion for modifying the input text document; and
b. a tagger portion for tagging the input text document.

6. The system as recited in claim 5, wherein the tagger portion tags text with XML tags.

7. A computer program product for use with a computer, the computer program product comprising a computer usable medium having a computer readable program code embodied therein for automatically tagging text in an input text document, the computer program product taking as input a list of user-defined tags and a list of keywords corresponding to the tags, the computer program code performing the steps of:
a. modifying the input text document; and
b. tagging the input text document by repeatedly selecting a tag from the list of user-defined tags, and tagging text in the input text document that has keywords corresponding to this selected tag.

8. The computer program product as recited in claim 7, wherein the modifying step comprises the steps of:
a. checking spelling of words in the input text document;
b. removing stop words from the input text document;
c. replacing synonyms of words in the input text document; and
d. decomposing sentences and parts of speech in the input text document.

9. The computer program product as recited in claim 7, wherein the tagging step comprises the steps of:
a. selecting a tag from the list of user-defined tags;
b. searching the input text document for text containing keywords corresponding to the selected tag;
c. tagging text in the input text document with tags, if the text has keywords corresponding to the selected tag;
d. iteratively repeating steps a and b until all tags in the list of user-defined tags have been selected; and
e. displaying the tagged input text document.

10. The computer program product as recited in claim 9, wherein the tagging step comprises enclosing the text with XML tags.

11. A method for automatically tagging text in an input text document, the method taking as input a list of user-defined tags and a list of keywords corresponding to the tags, the method comprising the steps of:
a. modifying the input text document to increase informational content and minimized overlapping tags;
wherein modifying the input text document to increase informational content and minimized overlapping tags comprises:
i. checking spelling of words in the input text document;
ii. removing stop words from the input text document;
iii. replacing synonyms of words in the input text document; and
iv. decomposing sentences and parts of speech in the input text document; and
b. tagging the input text document with XML tags;
wherein tagging the input text document with XML tags comprises:
i. selecting a tag from the list of user-defined tags;
ii. searching the input text document for text containing keywords corresponding to the selected tag;
iii. tagging text in the input text document with tags, if the text has keywords corresponding to the selected tag;
iv. iteratively repeating steps i and ii until all tags in the list of user-defined tags have been selected; and
v. displaying the tagged input text document.

12. A system for automatically tagging text in an input text document, the system taking as input a list of user-defined tags and a list of keywords corresponding to the tags, the system comprising:
a. a modifier portion for modifying the input text document to increase informational content and minimize overlapping tags;
wherein the modifier portion:
i. checks the spelling of words in the input text document;
ii. removes stop words from the input text document;
iii. replaces synonyms of words in the input text document; and
iv. decomposes sentences and parts of speech in the input text document; and
b. a tagger portion for tagging the input text document with XML tags;
wherein the tagger portion:
i. selects a tag from the list of user-defined tags;
ii. searches the input text document for text containing keywords corresponding to the selected tag;
iii. tags text in the input text document with tags, if the text has keywords corresponding to the selected tag;
iv. iteratively repeats steps a and b until all tags in the list of user-defined tags have been selected; and
v. displays the tagged input text document.

13. A computer program product for use with a computer, the computer program product comprising a computer usable medium having a computer readable program code embodied therein for for automatically tagging text in an input text document, the computer program product taking as input a list of user-defined tags and a list of keywords corresponding to the tags, the computer program code performing the steps of:
a. modifying the input text document to increase informational content and minimized overlapping tags;
wherein modifying the input text document to increase informational content and minimized overlapping tags comprises:
i. checking spelling of words in the input text document;
ii. removing stop words from the input text document;
iii. replacing synonyms of words in the input text document; and
iv. decomposing sentences and parts of speech in the input text document; and
b. tagging the input text document with XML tags;
wherein tagging the input text document with XML tags comprises:
i. selecting a tag from the list of user-defined tags;
ii. searching the input text document for text containing keywords corresponding to the selected tag;
iii. tagging text in the input text document with tags, if the text has keywords corresponding to the selected tag;
iv. iteratively repeating steps i and ii until all tags in the list of user-defined tags have been selected; and
v. displaying the tagged input text document.
